(19) United States
(12) Patent Application Publication
(10) Pub. No.: US 2025/0296827 A1
(43) Pub. Date: Sep. 25, 2025

(54) Split-able funnel

(71) Applicant: William James Prouty, Brush Prairie, WA (US)

(72) Inventor: William James Prouty, Brush Prairie, WA (US)

(21) Appl. No.: 19/060,281

(22) Filed: Feb. 21, 2025

Related U.S. Application Data
(60) Provisional application No. 63/569,565, filed on Mar. 25, 2024.

(51) Int. Cl. B67C 11/02

(52) U.S. Cl. CPC B67C 11/02; B67C 2011/027

(57) ABSTRACT

A split-able funnel device designed for efficient liquid transfer and easy cleaning. The funnel features a conical body that tapers from a wide opening to a narrow stem, allowing precise pouring into small containers. The innovative design includes a longitudinal split, enabling the funnel to open fully for thorough cleaning and convenient storage. The device incorporates a snap-fit or hinged splitting mechanism for secure assembly and easy separation. Additionally, the funnel body includes measurement markings for accurate liquid transfer and a filter mechanism for separating solids from liquids. Constructed from durable, flexible materials, the lightweight funnel is stackable and available in various sizes and colors, making it suitable for diverse applications. This split-able funnel device minimizes spillage and waste, providing a user-friendly solution for clean and efficient liquid transfer.

### FIELD OF THE INVENTION

The present invention relates to the field of liquid transfer tools, specifically to a novel design of a funnel intended for transferring automotive oils and various liquids in a controlled manner, with an emphasis on ease of cleaning.

### BACKGROUND OF THE INVENTION

A funnel intended for transferring automotive oils and various liquids in a controlled manner, with an emphasis on ease of cleaning, is in high demand.

Funnels have been essential tools in various applications, from automotive maintenance to kitchen use, for transferring liquids from one container to another, especially when the receiving container has a small opening.

Traditional funnels are typically made from a single piece of material, forming a conical shape with a stem to direct the flow of liquid. While effective in directing flow, these conventional designs often pose significant challenges in cleaning, particularly when used with viscous or sticky substances.

Residual liquid can adhere to the interior surfaces, leading to contamination, odor, or the necessity for cumbersome cleaning methods. For instance, the use of the same funnel for different applications can introduce contaminants into the lubricant, as highlighted in industry discussions. Moreover, traditional funnels are usually made from rigid materials, which do not allow for easy access to the interior for thorough cleaning. This limitation not only complicates the cleaning process but also discourages the use of funnels for certain applications where hygiene or cross-contamination is a concern.

Several attempts have been made to improve the functionality of funnels, including designs that are collapsible or made from flexible materials. While these innovations offer some improvements, particularly in terms of storage and handling, they still fall short in addressing the core issue of ease of cleaning.

Additionally, most existing designs do not provide a solution for keeping the funnel parts together when not in use, leading to the potential loss of components or the need for additional storage solutions.

Furthermore, the potential for contamination when using the same funnel for different liquids is a significant concern in both automotive and culinary applications. This highlights the need for a funnel that not only facilitates easy and thorough cleaning but also addresses the issues of storage, handling, and the risk of losing parts.

Thus, there is a need to develop a funnel design that incorporates features allowing for easy disassembly for cleaning, secure storage solutions, and the ability to maintain hygiene standards across various applications.

The present invention is intended to solve the problems associated with conventional devices and methods and provide improvements on these devices.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present invention is designed to enhance the efficiency and ease of liquid transfer while addressing the challenges of cleaning and storage. The funnel features a conical body that tapers from a wide opening at the top to a narrow stem at the bottom, allowing for precise pouring into containers with small openings. The body is split longitudinally into two halves, enabling full opening for cleaning and convenient separation for storage.

The funnel incorporates a splitting mechanism, which can be either a snap-fit design or a hinged design. In the hinged design, one edge of each half is connected by a hinge, allowing the funnel to open like a book for cleaning while ensuring the parts remain attached. The hinge can be any type known in the art, including but not limited to piano hinges, butt hinges, continuous hinges, and spring-loaded hinges.

Constructed from durable, flexible materials such as plastic or silicone, the funnel is lightweight and resistant to chemicals and heat, making it suitable for various applications. The design accommodates a range of liquid transfer needs, from automotive oils to kitchen ingredients, while minimizing spills and waste.

In alternative embodiments, the funnel may include measurement markings along its surfaces for precise liquid transfer, a filter mechanism at the base for separating solids from liquids, and a spout designed to facilitate controlled pouring, which can be any spout known in the art, including but not limited to tapered spouts, wide-mouth spouts, and precision pouring spouts. Additionally, the funnel features a stackable design for efficient storage.

This innovative split-able funnel device provides a versatile, user-friendly solution for liquid transfer, making it an essential tool in various settings.

### BRIEF DESCRIPTION OF THE DRAWINGS

FIG. 1 is an illustration of one embodiment of the present invention.

FIG. 2 is an illustration of one embodiment of the present invention in an opened state.

FIG. 3 is an illustration of one embodiment of the present invention with a spout that can be attached to the bottom of the body of the present invention.

### DETAIL DESCRIPTIONS OF THE INVENTION

All illustrations of the drawings are for the purpose of describing selected versions of the present invention and are not intended to limit the scope of the present invention.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term-differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present invention (split-able funnel) provides a significant improvement over traditional funnel designs, addressing the longstanding issue of cleaning difficulty while providing a versatile and user-friendly solution for a wide range of applications. The present invention's innovative design, combining functionality with ease of maintenance, makes it an essential tool in any setting where liquids are transferred.

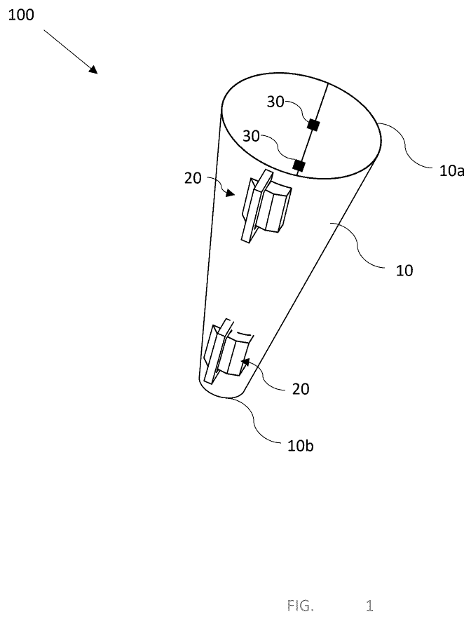

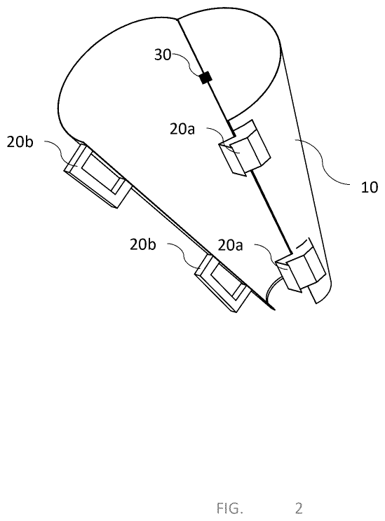

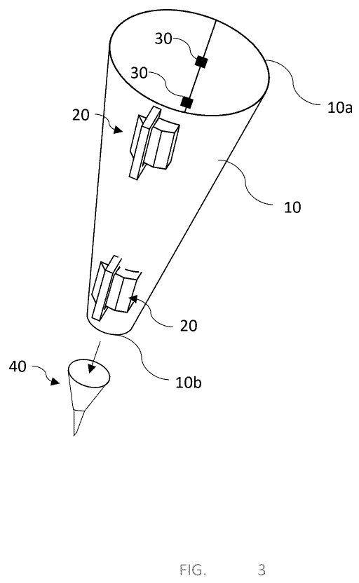

The present invention, split-able funnel 100, as shown in FIGS. 1-3, comprises two primary components: the funnel body 10 and the splitting mechanism 20, 30. The funnel body 10 is conically shaped, tapering from a wide opening at the top to a narrow stem at the bottom, designed for directing the flow of liquids into containers with small openings. The body 10 is split longitudinally into two halves, allowing it to be fully opened for cleaning or separated for storage.

In one embodiment, the split-able funnel device 100 may comprise:
a body 10 having a conical shape tapering from a wide opening at the top 10a to a narrow stem at the bottom 10b, wherein the body 10 is split longitudinally into two halves to allow for full opening for cleaning and separation for storage; and a splitting mechanism 20, 30 selected from the group consisting of a snap-fit design 20 and a hinged design 30.

In accordance with this embodiment, the splitting mechanism 20,30 can be implemented in two forms: a snap-fit design 20 or a hinged design 30.

In the snap-fit design 20, the two halves of the funnel body can be equipped with clips 20a or interlocking grooves 20b along their edges, allowing them to be securely fastened together during use and easily separated for cleaning.

In the hinged design 30, one edge of each half can be connected by a hinge, enabling the funnel to be opened like a book for cleaning while ensuring the parts remain attached and cannot be lost. The hinge can be any hinge known in the art, including but not limited to piano hinges, butt hinges, continuous hinges, and spring-loaded hinges.

In some embodiments, the funnel 100 can be constructed from a moldable material, such as plastic, silicone, or any suitable polymer that is durable, flexible, and resistant to chemicals and heat. This choice of material facilitates the manufacturing of the funnel in various sizes and colors, as well as ensuring the product is lightweight, easy to handle, and capable of withstanding the rigors of frequent use and cleaning.

In some embodiments, the body 100 may include materials designed to withstand temperatures ranging from −20° C. to 100° C.

In an alternative embodiment, the split-able funnel device 100 may comprise: a body 10 having measurement markings along the interior or exterior surfaces for precise liquid transfer; and a filter mechanism located at the base 10b of the body 10 for separating solids from liquids during a pouring process.

In another alternative embodiment, the split-able funnel device 100 may comprise: a body 10 designed to minimize drips and spills during pouring, featuring a spout 40 that facilitates controlled pouring; a lightweight construction for ease of handling; and a stackable design for efficient storage. The spout 40 can be any spout known in the art, including but not limited to tapered spouts, wide-mouth spouts, and precision pouring spouts.

The stackable design for efficient storage may allow multiple funnels 100 to be securely nested within one another. This design can include features such as a tapered shape or interlocking edges that prevent the funnels from shifting or falling over when stacked. Additionally, the stackable design may incorporate a locking mechanism or alignment guides to ensure stability during storage, making it easy to organize and access multiple funnels without taking up excessive space in cabinets or toolboxes.

In the preferred embodiment, as shown in FIGS. 1-3, the present invention is designed for ease of use and maintenance. The ability to fully open or separate the funnel 100 into two halves provides unprecedented access to the interior surfaces, making cleaning simple and effective. This feature is particularly advantageous when the funnel is used with viscous, sticky, or otherwise messy liquids, ensuring that no residue remains that could contaminate future uses.

The design of the funnel 100, with its varying sizes, accommodates a wide range of liquid transfer needs, from automotive oils to kitchen ingredients. The controlled pouring facilitated by the conical shape and narrow stem reduces spillage and waste, making the process more efficient and clean.

While the preferred embodiments have been described, variations to the design and structure of the split-able funnel 100 are possible.

Although the invention has been explained in relation to its preferred embodiment, it is to be understood that many other possible modifications and variations can be made without departing from the spirit and scope of the invention.

What is claimed is:

1. A split-able funnel device comprising:
a body having a conical shape tapering from a wide opening at the top to a narrow stem at the bottom, wherein the body is split longitudinally into two halves to allow for full opening for cleaning and separation for storage; and
a splitting mechanism selected from the group consisting of a snap-fit design and a hinged design.

2. The split-able funnel device of claim 1, wherein the body is constructed from a moldable material selected from the group consisting of plastic, silicone, and suitable polymers that are durable, flexible, and resistant to chemicals and heat.

3. The split-able funnel device of claim 2, further comprising a plurality of clips and hinges that facilitate secure fastening of the two halves during use and allow for easy separation for cleaning.

4. The split-able funnel device of claim 2, wherein the snap-fit design includes interlocking grooves along edges of the two halves.

5. The split-able funnel device of claim 3, wherein the hinged design includes a hinge connecting one edge of each half, enabling the funnel to open like a book.

6. A split-able funnel device comprising:
a body having measurement markings along the interior or exterior surfaces for precise liquid transfer; and
a filter mechanism located at a base of the body for separating solids from liquids during a pouring process.

7. The split-able funnel device of claim 6, wherein the body is designed to accommodate a variety of sizes to facilitate the transfer of different types of liquids, including automotive oils and kitchen ingredients.

8. The split-able funnel device of claim 7, wherein the conical shape and narrow stem of the body are designed to control the pouring of liquids, thereby reducing spillage and waste during use.

9. The split-able funnel device of claim 7, wherein the body is designed to withstand temperatures ranging from −20° C. to 100° C.

10. The split-able funnel device of claim 6, wherein the body is available in multiple colors for aesthetic customization.

11. A split-able funnel device comprising:
a body designed to minimize drips and spills during pouring, featuring a spout that facilitates controlled pouring;
a lightweight construction for ease of handling; and
a stackable design for efficient storage.

12. The split-able funnel device of claim 11, wherein the body includes a non-slip grip feature to enhance user control during pouring.

13. The split-able funnel device of claim 12, wherein the body is dishwasher safe for convenient cleaning.

14. The split-able funnel device of claim 13, wherein the body is designed to accommodate a wide range of liquid viscosities, from thin liquids to thick pastes.

15. The split-able funnel device of claim 13, wherein the body includes measurement markings along the interior or exterior surfaces for precise liquid transfer.

16. The split-able funnel device of claim 13, wherein the body is designed to be stackable for efficient storage.

17. The split-able funnel device of claim 16, wherein the body is designed to minimize drips and spills during pouring.

18. The split-able funnel device of claim 11, wherein the body is designed to be compatible with standard container openings for efficient liquid transfer.

19. The split-able funnel device of claim 11, wherein the body is designed to withstand frequent use and cleaning without degradation.

20. The split-able funnel device of claim 11, wherein the body is designed to be resistant to staining from colored liquids.
